(19) United States
(12) Patent Application Publication
(10) Pub. No.: US 2026/0169922 A1
(43) Pub. Date: Jun. 18, 2026

(54) RELIABILITY AVAILABILITY SERVICEABILITY SOLUTIONS FOR COMPUTE EXPRESS LINK DEVICES WITH REDUCED OVERPROVISIONING

(71) Applicant: Micron Technology, Inc., Boise, ID (US)

(72) Inventors: Marco Sforzin, Cernusco Sul Naviglio MI (IT); Su Wei Lim, Bayan Lepas (MY)

(21) Appl. No.: 19/394,211

(22) Filed: Nov. 19, 2025

Related U.S. Application Data
(60) Provisional application No. 63/735,756, filed on Dec. 18, 2024.

(51) Int. Cl. G06F 12/0862

(52) U.S. Cl. CPC G06F 12/0862; G06F 2212/602

(57) ABSTRACT

Systems and methods are disclosed, including prefetching, by a memory controller of a memory system of the computing system, at least two cache lines as a combined cache line in response to a memory access request from a host system of the computing system; and performing, by the memory controller, reduced chip fail error recovery to detect errors on data of the combined cache line.

### PRIORITY APPLICATION

This application claims the benefit of priority to U.S. Provisional Application Ser. No. 63/735,756, filed Dec. 18, 2024, which is incorporated herein by reference in its entirety.

### BACKGROUND

Memory devices are semiconductor circuits that provide electronic storage of data for a host system (e.g., a computer or other electronic device). Memory devices may be volatile or non-volatile. Volatile memory requires power to maintain data and includes devices such as random-access memory (RAM), static random-access memory (SRAM), dynamic random-access memory (DRAM), or synchronous dynamic random-access memory (SDRAM), among others.

Host systems (or hosts) typically include a host processor, a first amount of main memory (e.g., often volatile memory, such as DRAM) to support the host processor, and one or more memory systems (e.g., often non-volatile memory, such as flash memory, and may include volatile memory) that provide additional storage to retain data in addition to or separate from the main memory.

A memory system can include a memory controller and one or more memory devices, including a number of dies or logical units (LUNs). In certain examples, each die can include a number of memory arrays and peripheral circuitry thereon, such as die logic or a die processor. The memory controller can include interface circuitry configured to communicate with a host (e.g., the host processor or interface circuitry) through a communication link (e.g., a bidirectional parallel or serial communication interface). The memory controller can receive commands or operations from the host system in association with memory operations or instructions, such as read or write operations to transfer data (e.g., user data and associated integrity data, such as error data or address data, etc.) between the memory devices and the host device, erase operations to erase data from the memory devices, perform drive management operations (e.g., data migration, garbage collection, block retirement), etc.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a diagram of an example computing system including a host system and a memory system.

FIG. 2 is a block diagram of portions of an example of a memory system.

FIG. 3 is a diagram of an example of a prefetch of memory data from multiple memory dies.

FIG. 4 is a diagram of an example of a Reed Solomon (RS) approach to chip fail error recovery.

FIG. 5 is a diagram of an example of a Locked Redundant Independent Array (LRAID) approach to chip fail error recovery.

FIG. 6 is a diagram of an example of a prefetch of user data blocks (UDBs) from multiple memory dies of a memory system.

FIG. 7 is a diagram of another example of a prefetch of UDBs from multiple memory dies of a memory system.

FIG. 8 is a diagram of an example of a cache line of two UDBs with asymmetric error protection for reads and writes

FIG. 9 is a diagram of an example of a prefetch of memory data from multiple memory dies with reduced LRAID chip fail error recovery.

FIG. 10 is a diagram of an example of a prefetch of memory data from multiple memory dies with reduced RS chip fail error recovery.

FIG. 11 is a diagram of another example of a prefetch of UDBs from multiple memory dies of a memory system

FIG. 12 is a diagram of another example of a prefetch of UDBs from multiple memory dies of a memory system.

FIGS. 13-15 show examples of errors in the combined cache line of FIG. 12.

FIG. 16 is an example of prefetching a larger cache line with reduced overprovisioning.

FIGS. 17-19 show examples of errors in the combined cache line of FIG. 15.

FIGS. 20A-20B are a diagram summarizing the techniques of reducing overprovisioning.

FIG. 21 is a flow diagram of an example of a method of operating a computing system.

FIG. 22 illustrates an example block diagram of a computing system.

### DETAILED DESCRIPTION

Software (e.g., programs), instructions, operating systems (OS), and other data are typically stored on storage systems and accessed for use by a host processor. Main memory (e.g., RAM) is typically faster, more expensive, and a different type of memory device (e.g., volatile) than a majority of the memory devices of the memory system (e.g., non-volatile, such as an SSD, etc.). In addition to the main memory, host devices can include different levels of volatile memory, such as a group of static memory (e.g., a cache, often SRAM), often faster than the main memory, in certain examples, configured to operate at speeds close to or exceeding the speed of the host processor, but with lower density and higher cost.

Memory devices include individual memory die, which may, for example, include including a storage region comprising one or more arrays of memory cells, implementing one (or more) selected storage technologies. Such memory die will often include support circuitry for operating the memory array(s). Other examples, sometimes known generally as “managed memory devices,” include assemblies of one or more memory die associated with controller functionality configured to control operation of the one or more memory dies. Such controller functionality can simplify interoperability with an external host device. In such managed memory devices, the controller functionality may be implemented on one or more dies also incorporating a memory array, or on a separate die. In other examples, one or more memory devices may be combined with controller functionality to form a solid-state drive (SSD) storage volume.

Embodiments of the present disclosure are described in the example of managed memory devices implementing NAND flash memory cells. These examples can be referred to as managed NAND or mNAND devices. These examples, however, are not limited to the scope of the disclosure, which may be implemented in other forms of memory devices and/or with other forms of storage technology.

Both NOR and NAND flash architecture semiconductor memory arrays are accessed through decoders that activate specific memory cells by selecting the word line coupled to their gates. In a NOR architecture semiconductor memory array, once activated, the selected memory cells place their data values on bit lines, causing different currents to flow depending on the state at which a particular cell is programmed. In a NAND architecture semiconductor memory array, a high bias voltage is applied to a drain-side select gate (SGD) line. Word lines coupled to the gates of the unselected memory cells of each group are driven at a specified pass voltage (e.g., Vpass) to operate the unselected memory cells of each group as pass transistors (e.g., to pass current in a manner unrestricted by their stored data values). Current then flows from the source line to the bit line through each series coupled group, restricted only by the selected memory cells of each group, placing current encoded data values of selected memory cells on the bit lines.

Each flash memory cell in a NOR or NAND architecture semiconductor memory array can be programmed individually or collectively to one or a number of programmed states. For example, a single-level cell (SLC) can represent one of two programmed states (e.g., 1 or 0), representing one bit of data. Flash memory cells can also represent more than two programmed states, allowing the manufacture of higher density memories without increasing the number of memory cells, as each cell can represent more than one binary digit (e.g., more than one bit). Such cells can be referred to as multi-state memory cells, multi-digit cells, or multi-level cells (MLCs). In certain examples, MLC can refer to a memory cell that can store two bits of data per cell (e.g., one of four programmed states), a triple-level cell (TLC) can refer to a memory cell that can store three bits of data per cell (e.g., one of eight programmed states), and a quad-level cell (QLC) can store four bits of data per cell. MLC is used herein in its broader context, to refer to any memory cell(s) that can store more than one bit of data per cell (i.e., that can represent more than two programmed states).

Managed memory devices may be configured and operated in accordance with recognized industry standards. For example, managed NAND devices may be (as non-limiting examples), a Universal Flash Storage (UFS™) device, or an embedded MMC device (eMMC™), etc. For example, in the case of the above examples, UFS devices may be configured in accordance with Joint Electron Device Engineering Council (JEDEC) standards (e.g., JEDEC standard JESD223D, entitled JEDEC UFS Flash Storage 3.0, etc., and/or updates or subsequent versions to such standard. Similarly, identified eMMC devices may be configured in accordance with JEDEC standard JESD84-A51, entitled “JEDEC eMMC standard 5.1”, again, and/or updates or subsequent versions to such standard.

An SSD can be used as, among other things, the main storage device of a computer, having advantages over traditional hard drives with moving parts with respect to, for example, performance, size, weight, ruggedness, operating temperature range, and power consumption. For example, SSDs can have reduced seek time, latency, or other delay associated with magnetic disk drives (e.g., electromechanical, etc.). SSDs use non-volatile memory cells, such as flash memory cells to obviate internal battery supply requirements, thus allowing the drive to be more versatile and compact. Managed memory devices, for example managed NAND devices, can be used as primary or ancillary memory in various forms of electronic devices, and are commonly used in mobile devices.

Managed memory devices can include a number of memory devices, including a number of dies or logical units (e.g., logical unit numbers or LUNs), and can include one or more processors or other controllers performing logic functions required to operate the memory devices or interface with external systems. Such managed memory devices can include one or more flash memory dies, including a number of memory arrays and peripheral circuitry thereon. The flash memory arrays can include a number of blocks of memory cells organized into a number of physical pages. Managed NAND devices can include one or more arrays of volatile and/or nonvolatile memory separate from the NAND storage array, and either within or separate from a controller. Both SSDs and managed NAND devices can receive commands from a host or a host in association with memory operations, such as read or write operations to transfer data (e.g., user data and associated integrity data, such as error data and address data, etc.) between the memory devices and the host, or erase operations to erase data from the memory devices.

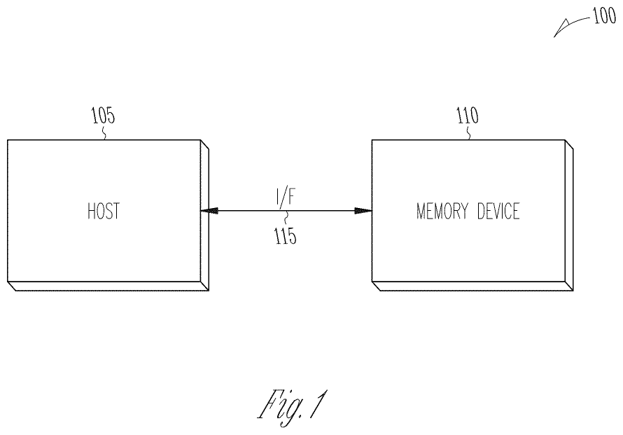

FIG. 1 illustrates an example computing system 100 including a host system or host 105 and a memory system 110. The host 105 can include a host processor, a central processing unit, or one or more other device, processor, or controller. The memory system 110 can include one or more other memory devices, and the communication interface 115 (I/F) can include one or more other interfaces, depending on the host 105 and the memory system 110. Each of the host 105 and the memory system 110 can include a number of receiver or driver circuits configured to send or receive signals over the communication interface 115, or interface circuits, such as data control units, sampling circuits, or other intermedia circuits configured to process data to be communicated over, or otherwise process data received from the communication interface 115 for use by the host 105, the memory system 110, or one or more other circuits or devices.

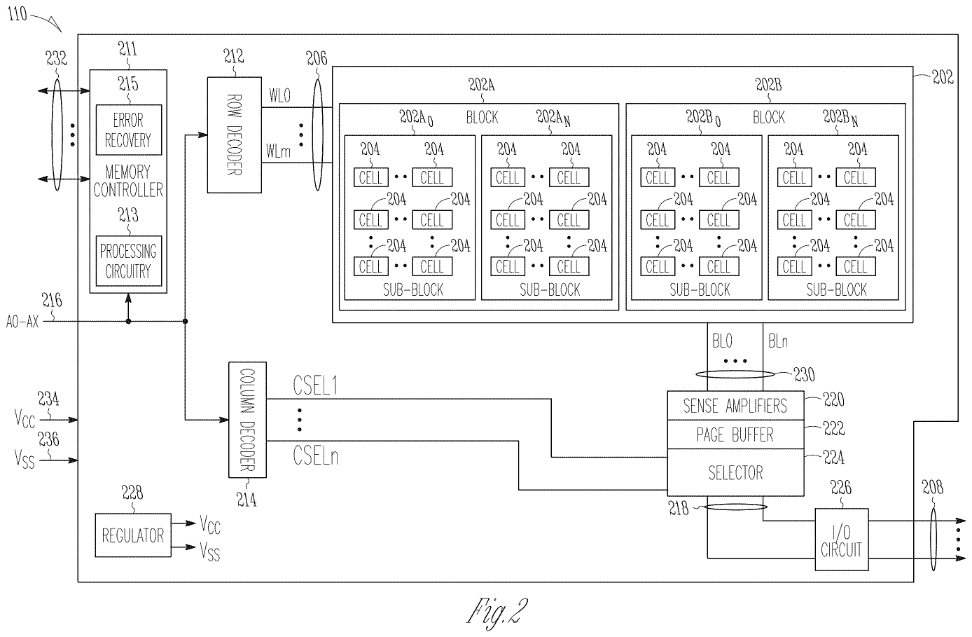

FIG. 2 illustrates an example block diagram of portions of a memory system 110 including a memory array 202 having a plurality of memory cells 204, and one or more circuits or components to provide communication with, or perform one or more memory operations on, the memory array 202. Although shown with a single memory array 202, in other examples, one or more additional memory arrays, dies, or LUNs can be included herein. The memory system 110 can include a row decoder 212, a column decoder 214, sense amplifiers 220, a page buffer 222, a selector 224, an input/output (I/O) circuit 226, and a memory controller 211.

The memory cells 204 of the memory array 202 can be arranged in blocks, such as first and second blocks 202A, 202B. Each block can include sub-blocks. For example, the first block 202A can include first and second sub-blocks 202A₀, 202Aₙ, and the second block 202B can include first and second sub-blocks 202B₀, 202Bₙ. Each sub-block can include a number of physical pages, each page including a number of memory cells 204. Although illustrated herein as having two blocks, each block having two sub-blocks, and each sub-block having a number of memory cells 204, in other examples, the memory array 202 can include more or fewer blocks, sub-blocks, memory cells, etc. In other examples, the memory cells 204 can be arranged in a number of rows, columns, pages, sub-blocks, blocks, etc., and accessed using, for example, access lines 206, first data lines 230, or one or more select gates, source lines, etc.

The memory controller 211 can control memory operations of the memory system 110 according to one or more signals or instructions received on control lines 232, including, for example, one or more clock signals or control signals that indicate a desired operation (e.g., write, read, erase, etc.), or address signals (A0-AX) received on one or more address lines 216. One or more devices external to the memory system 110 can control the values of the control signals on the control lines 232, or the address signals on the address line 216. Examples of devices external to the memory system 110 can include, but are not limited to, a host, a memory controller, a processor, or one or more circuits or components not illustrated in FIG. 2.

The memory system 110 can use access lines 206 and first data lines 230 to transfer data to (e.g., a write or erase operation) or from (e.g., a read operation) one or more of the memory cells 204. The row decoder 212 and the column decoder 214 can receive and decode the address signals (A0-AX) from the address line 216, can determine which of the memory cells 204 are to be accessed, and can provide signals to one or more of the access lines 206 (e.g., one or more of a plurality of word lines (WL0-WLm)) or the first data lines 230 (e.g., one or more of a plurality of bit lines (BL0-BLn)), such as described above.

The memory system 110 can include sense circuitry, such as the sense amplifiers 220, configured to determine the values of data on (e.g., read), or to determine the values of data to be written to, the memory cells 204 using the first data lines 230. For example, in a selected string of memory cells 204, one or more of the sense amplifiers 220 can read a logic level in the selected memory cell 204 in response to a read current flowing in the memory array 202 through the selected string to the data lines 230.

One or more devices external to the memory system 110 can communicate with the memory system 110 using the I/O lines (DQ0-DQN) 208, address lines 216 (A0-AX), or control lines 232. The input/output (I/O) circuit 226 can transfer values of data in or out of the memory system 110, such as in or out of the page buffer 222 or the memory array 202, using the I/O lines 208, according to, for example, the control lines 232 and address lines 216. The page buffer 222 can store data received from the one or more devices external to the memory system 110 before the data is programmed into relevant portions of the memory array 202 or can store data read from the memory array 202 before the data is transmitted to the one or more devices external to the memory system 110.

The column decoder 214 can receive and decode address signals (A0-AX) into one or more column select signals (CSEL1-CSELn). The selector 224 (e.g., a select circuit) can receive the column select signals (CSEL1-CSELn) and select data in the page buffer 222 representing values of data to be read from or to be programmed into memory cells 204. Selected data can be transferred between the page buffer 222 and the I/O circuit 226 using second data lines 218.

The memory system 110 can receive positive and negative supply signals, such as a supply voltage (Vcc) 234 and a negative supply (Vss) 236 (e.g., a ground potential), from an external source or supply (e.g., an internal or external battery, an AC-to-DC converter, etc.). In certain examples, the memory system 110 can include a regulator 228 to internally provide positive or negative supply signals.

In FIG. 2, the memory controller 211 includes controller processing circuitry 213 to perform the functions described for the memory controller 211. The controller processing circuitry 213 can include one or more processors (e.g., microprocessors), an application specific integrated circuit (ASIC), or programmable gate array (PGA).

Some memory systems incorporate Reliability, Availability, and Serviceability (RAS) features to minimize downtime by detecting and repairing memory errors. One type of RAS feature is chip fail recovery, which provides error checking and correcting to protect the memory system from failure of a single memory die or chip, and from multi-bit errors from a single memory die. Chip fail recovery typically involves overprovisioning of data bits by using extra data bits for error detection and correction algorithms. The overprovisioning often adds 25% to the number of bits used for a data word.

FIG. 3 is a diagram of an example of a prefetch of memory data from multiple memory dies. The memory dies are numbered die 1 through die 10. A 64 Byte (64 B) data access uses dies 1-8 and dies 9-10 are used for error protection for the data access. For instance, a memory read would read 64 B of data in parallel from dies 1-8 and read 16 B of information for chip fail recovery from dies 9 and 10. Thus, 25% overprovisioning (OP) is used for chip fail recovery. A memory write would write 64 B of data in parallel to the memory dies 1-8 and write 16 B of information for chip fail recovery to dies 9 and 10.

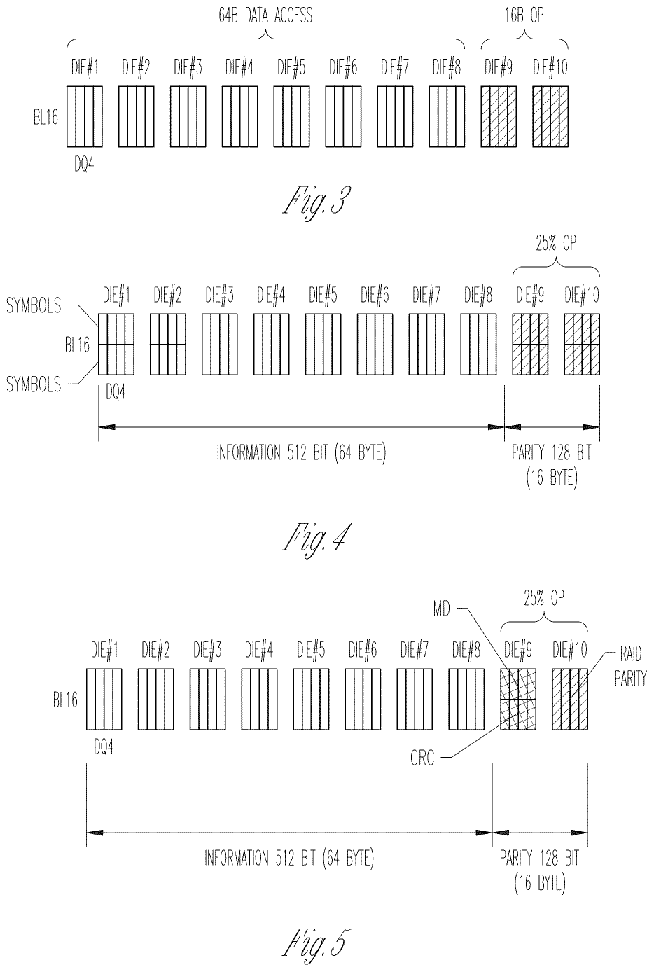

FIG. 4 is a diagram of an example of a Reed Solomon (RS) approach to chip fail recovery. Each 64 B data word in memory is stored as a codeword that is the data word plus parity bits. Each codeword is grouped into bits called symbols and the symbols are evenly striped across the memory dies. The parity bits allow the RS algorithm to correct one bad symbol per codeword and detect two bad symbols per codeword. If the codewords are grouped as four symbols, any of the four symbols can be corrected if it is bad, and errors can be detected in any two of the symbols.

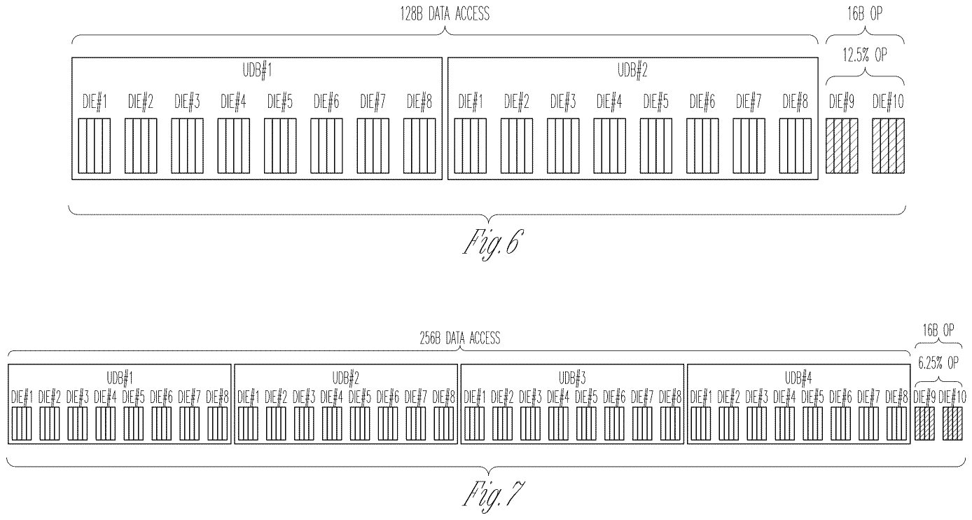

FIG. 5 is a diagram of an example of a locked redundant array independent disk (LRAID) approach to chip fail recovery. Each 64 B data word in memory is stored in association with metadata (MD) bits provided by the host (e.g., 32 metadata bits). Cyclic Redundancy Code (CRC) bits (e.g., 32 bits) are determined over the data word and the metadata. Parity bits are determined for the data ward, the metadata, and the CRC. The example of FIG. 5 shows the metadata and the CRC stored in die 9 and the parity stored in die 10. Both the approaches in the examples of FIGS. 4 and 5 use 16 B of overprovisioning for 64 B of data, or 25% overprovisioning.

It may be desired to provide RAS solutions such as chip fail recovery with reduced overprovisioning to reduce storage overhead. The memory controller 211 in FIG. 2 performs memory access operations with reduced overprovisioning bits. The techniques that reduce overprovisioning include one or both of accessing a larger cache line with RAS operations performed on the larger cache line and reducing or removing the information for chip fail recovery protection. The techniques and their combinations may include different reductions in overprovisioning and may result in reduced bandwidth for memory access operations.

FIG. 6 is a diagram of an example of a prefetch of user data blocks (UDBs) from multiple memory dies of a memory system 110 that reduces the percentage of overprovisioning. The example of FIG. 6 differs from the example of FIG. 3 in that the controller processing circuitry 213 automatically prefetches multiple UDBs for a memory request as a combined cache line (e.g., two 64 B UDBs combined into one 128 B cache line. FIG. 2 shows that the memory controller 211 includes error recovery circuitry 215 to detect errors in memory data. The error recovery circuitry 215 provides full chip fail recovery over the multiple UDBs. The chip fail recovery may use either a Reed Solomon based error recovery algorithm or an LRAID based error recovery algorithm. In the example of FIGS. 3, 16 B were used for a 64 B data access or used 25% overprovisioning. In the example of FIG. 6, the error recovery circuitry 215 of the memory controller 211 uses 16 B for error recovery for a 128 B cache line, or 12.5% overprovisioning (OP). Accessing the memory data as a larger cache line reduces the overprovisioning bits needed from 25% of data to 12.5% of data. A comparison of FIGS. 3 and 6 shows that the reduction in overprovisioning can lead to two less memory die needed for RAS operations for two UDBs. The cost of reducing the overprovisioning is the decreased bandwidth. In the example of FIG. 6, doubling the size of the cache line reduces the bandwidth by half.

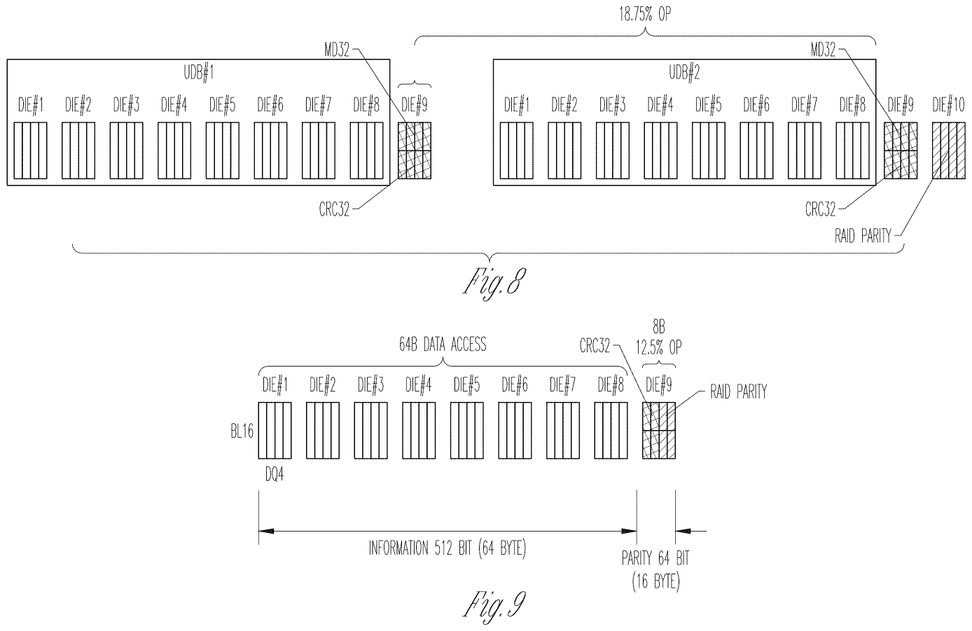

FIG. 7 is a diagram of another example of a prefetch of multiple UDBs from multiple memory dies of a memory system 110. The example of FIG. 7, the size of the combined cache line retrieved by the controller processing circuitry 213 increases to four UDBs. In the example of FIGS. 7, 16 B for error recovery used for a 256 B cache line reduces the overprovisioning to 6.25%. The cost of the reduction is a reduction in bandwidth to one-fourth of the bandwidth of the example of FIG. 3.

The reduction in bandwidth of the larger cache line can be partially mitigated using asymmetrical reads and writes. FIG. 8 is a diagram of an example of a cache line of two UDBs with asymmetric error protection for reads and writes. For read operations, the controller processing circuitry 213 accesses one UDB at a time and the cache line is 64 B. The error protection circuitry implements chip fail recovery using LRAID with 8 B of metadata and CRC for each UDB. LRAID parity is determined over the two UDBs. Only when the CRC check fails is the Raid parity accessed in a read operation. For a write operation, the UDBs are updated, the 8 B of metadata and CRC is updated, and the 8 B of RAID parity is updated. In the example of FIGS. 8, 24 B for error recovery is used for a 128 B cache line, or 18.75% overprovisioning. The bandwidth for read operations is not reduced if there is not a CRC check failure. In the four UDB example of FIG. 8, the error recovery circuitry 215 uses 8 B of metadata and CRC for each of the four UDBs and uses 8 B of LRAID parity for all four UDBs. Thus, 40 B of overprovisioning is used for 256 B of information, or 15.625% overprovisioning.

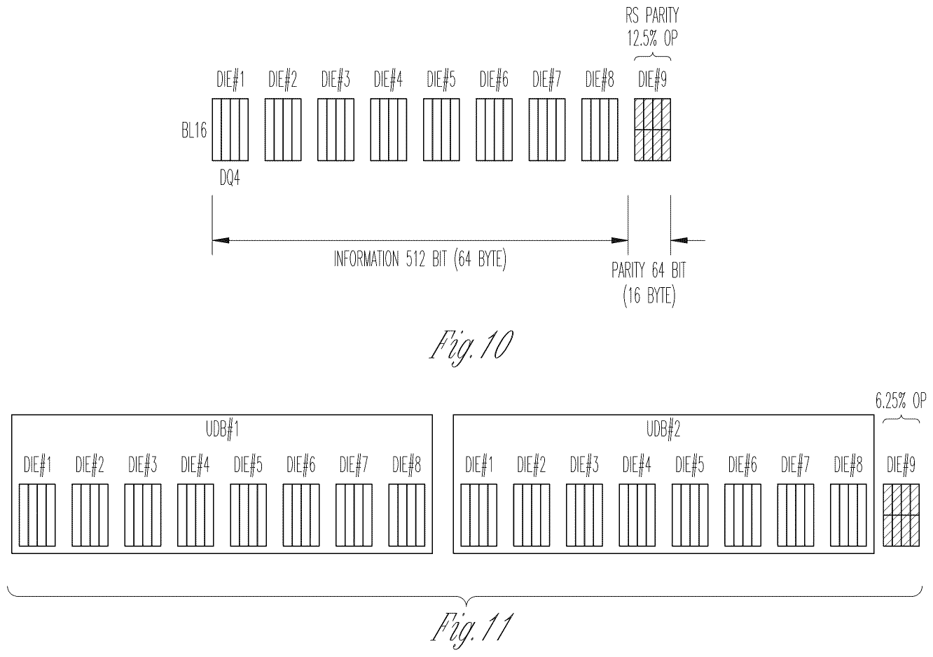

As explained previously herein, another approach to reducing overprovisioning is reducing or removing the chip fail recovery capability. FIG. 9 is a diagram of an example of a prefetch of memory data from multiple memory dies with reduced LRAID chip fail error recovery. Compared to the LRAID chip fail recovery protection example of FIG. 5, the error recovery circuitry 215 uses one-half the number of bits for CRC bytes and one-half the number of bits for RAID Parity. In the example of FIG. 9, one memory die (die 9) is used for providing RAS operations. Each of the memory dies provides 64 bits in parallel. Memory die 9 provides 32bits of CRC and 32 bits of RAID parity. The reduced number of CRC bits and RAID bits is used to provide chip fail recovery operations for only one half of the 64 B of data in the other memory dies. For example, only errors in the first half of the memory dies are correctable, and errors in the other half of the memory dies are not correctable. This can be referred to as half chip fail recovery. Thus, the chip fail recovery is reduced or removed compared to the example of FIG. 5 and full chip fail error recovery protection is not provided. Because the approach in FIG. 9 uses 8 B of overprovisioning for 64 B of data, the overprovisioning is reduced to 12.5%. The cost of the reduced overprovisioning is reduced or removed chip fail recovery. The bandwidth is not reduced.

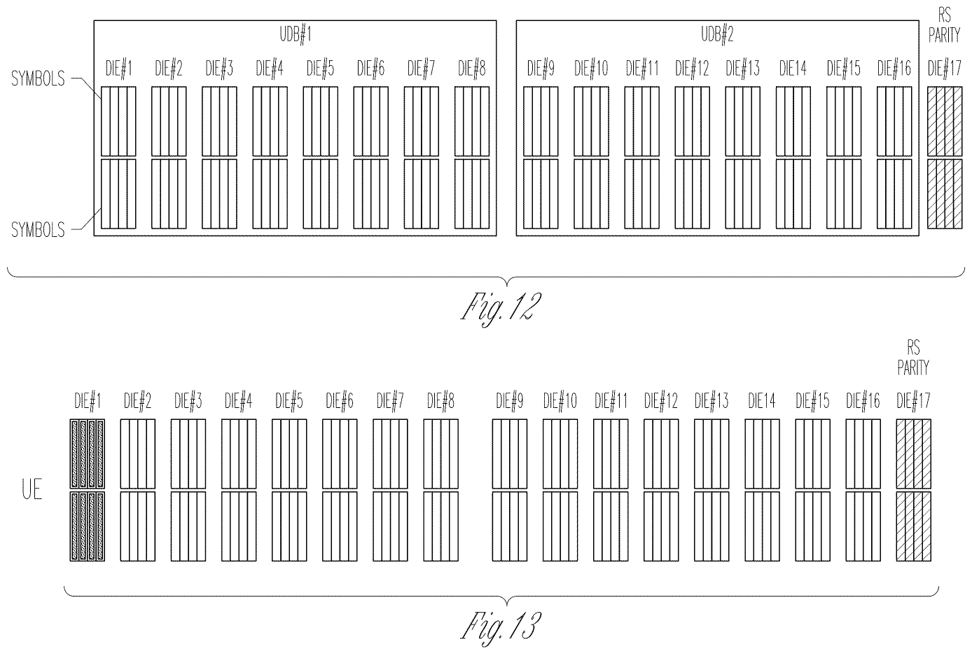

FIG. 10 is a diagram of an example of a prefetch of memory data from multiple memory dies with reduced RS chip fail error recovery. Compared to the RS chip fail protection example of FIG. 4, the error recovery circuitry 215 uses one-half the number of bits for parity. In the example of FIG. 10, one memory die (die 9) is used for parity. If the codewords are grouped to each include four symbols, the reduced number of parity bits allows for correcting two of the four symbols of a codeword but not more than two. Errors in more than two codewords is an uncorrectable error. Thus, the approach in FIG. 10 can be viewed as half chip fail recovery compared to the example of FIG. 4 or viewed as no chip fail recovery because full chip fail recovery is removed. Because the approach in FIG. 10 uses 8 B of overprovisioning for 64 B of data, the overprovisioning is reduced to 12.5%. The cost of the reduced overprovisioning is reduced or removed chip fail error recovery.

As explained previously herein, the approaches to reducing overprovisioning can be combined to use both accessing a larger cache line and reducing or removing the chip fail recovery protection on the larger cache line. The controller processing circuitry 213 automatically prefetches multiple UDBs for a memory request as a combined cache line and the error recovery circuitry 215 performs reduced chip fail recovery on the combined cache line.

FIG. 11 is a diagram of another example of a prefetch of user data blocks (UDBs) from multiple memory dies of a memory system 110. In the example of FIG. 11, two UDBs are accessed as a combined cache line of 128 B, and reduced chip fail recovery is performed on the two UDBs using 8 B. Because 8 B for error recovery is used for a 128 B cache line, the overprovisioning is reduced to 6.25%. The cost of the reduced overprovisioning is reduced chip fail error recovery and bandwidth is reduced by at least half. The reduced chip fail error recovery may use either RS or LRAID to detect and correct errors.

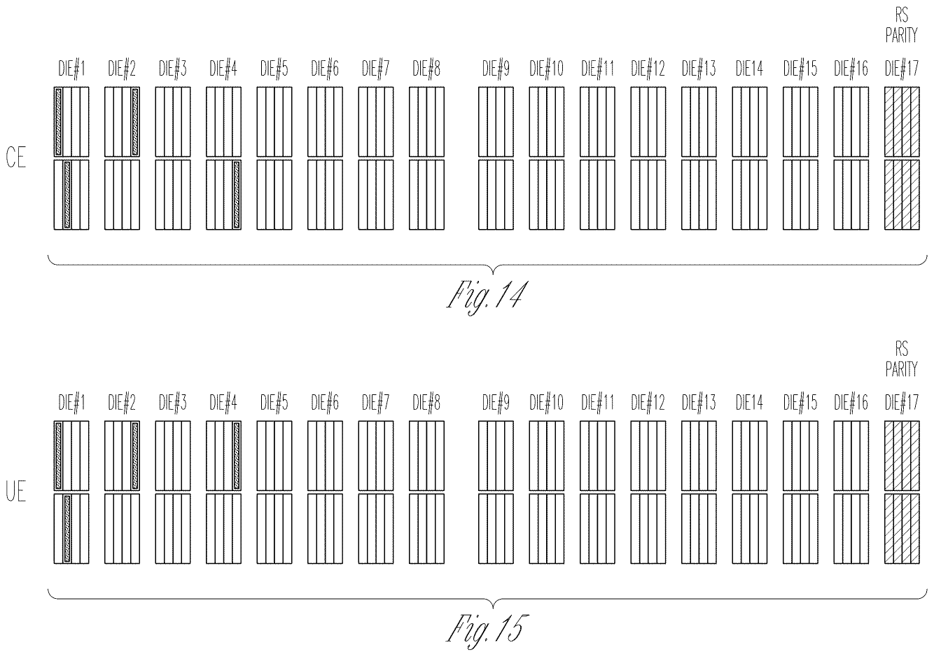

FIG. 12 is a diagram of an example of reduced overprovisioning by using an increased cache line size and reducing error recovery by reducing the information stored in memory for the error recovery. In the example of FIG. 12, die 17 is used to store RS parity for the UDBs. The combined cached line stores codewords having data that is striped across the multiple memory dies and RS parity stored in memory die 17. The codewords can be 68 B codewords having 8 bit symbols. The data bits and parity bits are split into two codewords striped across the memory dies.

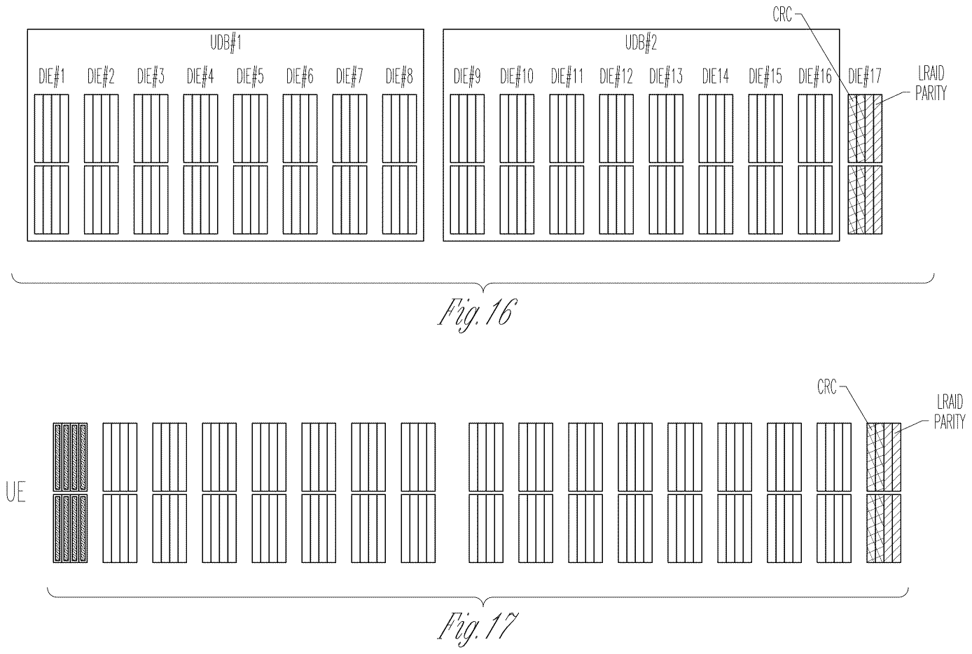

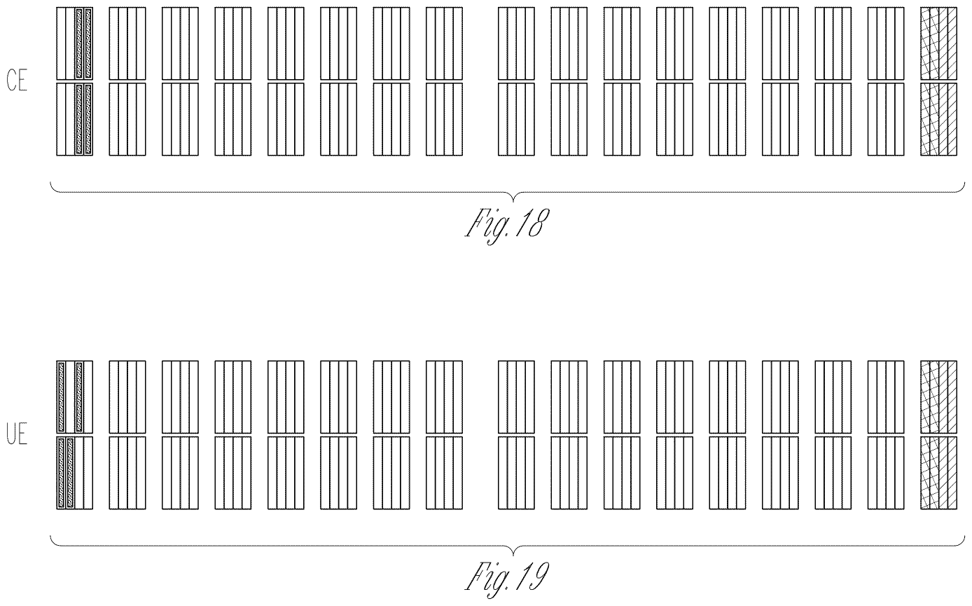

FIG. 13 shows an example of errors in the UDBs of the combined cache line of FIG. 12. Die 1 has data errors shown by the shaded symbols. Four symbols in each codeword have errors. The error is uncorrectable (UE) using chip fail recovery because of the reduced number of parity bits. Some errors are correctable with RS and the reduced overprovisioning. Errors are correctable if no more than two symbols are in error in a codeword. The error in FIG. 13 is an uncorrectable error (UE) because each codeword has four symbols with an error. FIG. 14 shows another example of the combined cache line of FIG. 12 with errors in die 1, die 2, and die 4. The error in FIG. 14 is a correctable error (CE) even with the reduced error recovery because the codewords have two symbols with errors. FIG. 15 shows another example of the combined cache line of FIG. 12 with errors in die 1, die 2, and die 4. The error in FIG. 15 is uncorrectable with the reduced overprovisioning because one codeword has three symbols with an error.

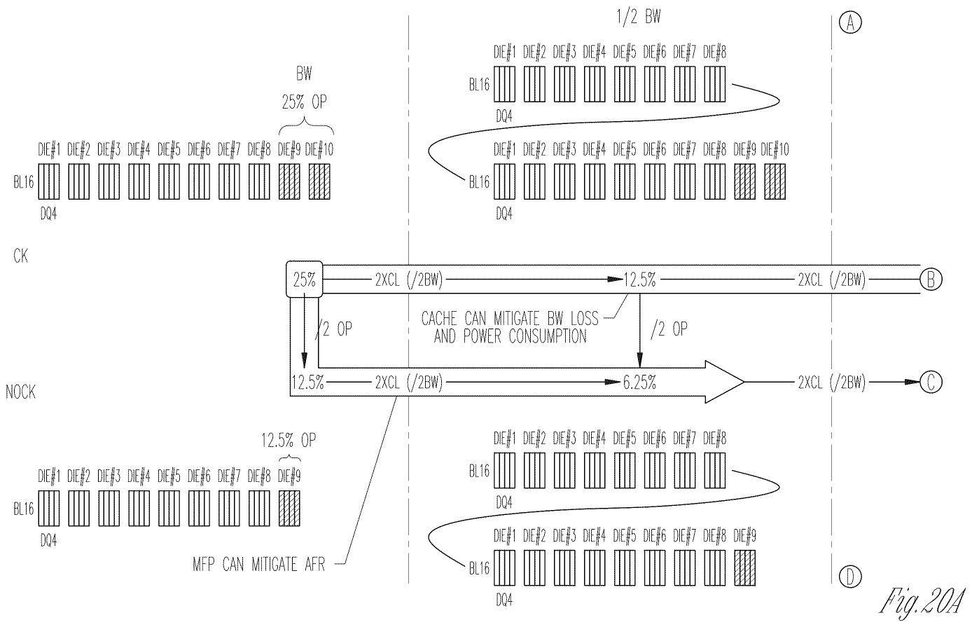

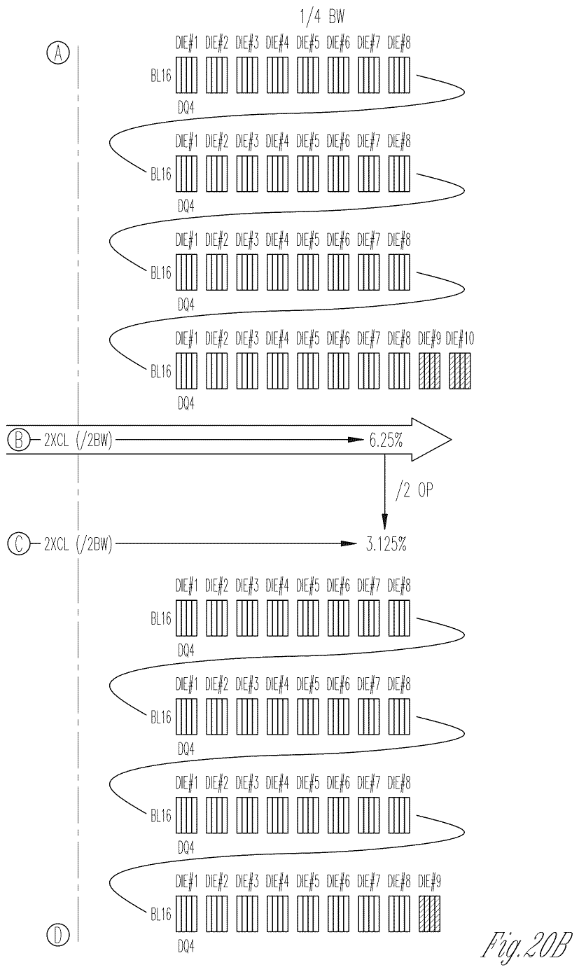

FIG. 16 is another example of prefetch of a larger cache line with reduced overprovisioning. In the example of FIG. 16, two UDBs are accessed as a combined cache line of 128 B, and reduced chip fail error recovery is performed on the two UDBs using 8 B and overprovisioning is reduced to 6.25%. The 8 B of die 17 are used to store CRC and LRAID parity. A split CRC check and LRAID parity may be computed for each half of two halves of the data striped across the 17 memory dies. FIG. 17 shows the combined cache line of FIG. 16 with four symbols in error in die 1. Like the example of FIG. 13, the error is uncorrectable with the reduced overprovisioning of FIG. 16. Some errors are correctable with LRAID and the reduced overprovisioning. FIG. 18 shows the combined cache line of FIG. 16 with errors in two symbols of die 1. The error is correctable because only two symbols of die 1 have errors. However, the symbols in error need to be next to each other to be correctable using CRC and LRAID parity. FIG. 19 shows an example of the combined cache line of FIG. 16 with errors in die 1. The errors are uncorrectable because the symbols in error are not next to each other.

Other combinations of cache line size and reduced overprovisioning are possible. The combinations may have different amounts of overprovisioning and cache line size. The different combinations can provide different reductions in overprovisioning with the penalty of reduced bandwidth and reduced chip fail error detection and correction. The desired balance between the reduction in overprovisioning and the reduction in bandwidth and error protection may depend on the implementation and can be determined by the designer.

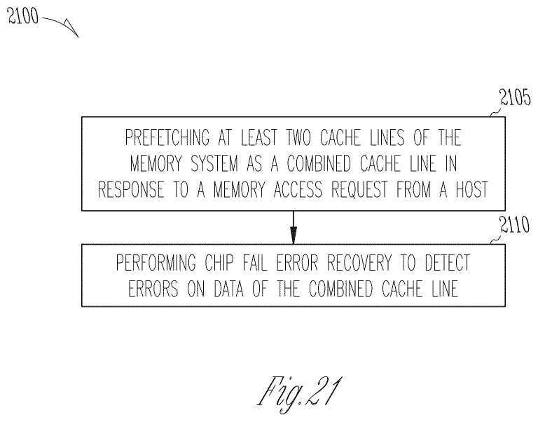

FIGS. 20A-20B are a diagram summarizing the techniques of reducing overprovisioning. The diagram shows six blocks. The block in the upper left of FIG. 20A shows the approach with one cache line and 25% overprovisioning of FIG. 3. The blocks in the upper right of FIG. 20A and upper portion of FIG. 20B show the effect of spreading the existing overprovisioning over larger cache lines. The diagram shows bandwidth is reduced in the upper blocks, but chip fail error recovery is preserved.

The block in the lower left of FIG. 20A shows the approach of reducing the number bits used in the overprovisioning. The bandwidth is preserved in the approach of the lower left block, but full chip fail error recovery is not available. The blocks in the lower right of FIG. 20A and lower portion of FIG. 20B show the effect of spreading the reduced overprovisioning bits over increased cache line size. Overprovisioning is reduced to as low as 3.125% but bandwidth is reduced, and chip fail recovery is not available.

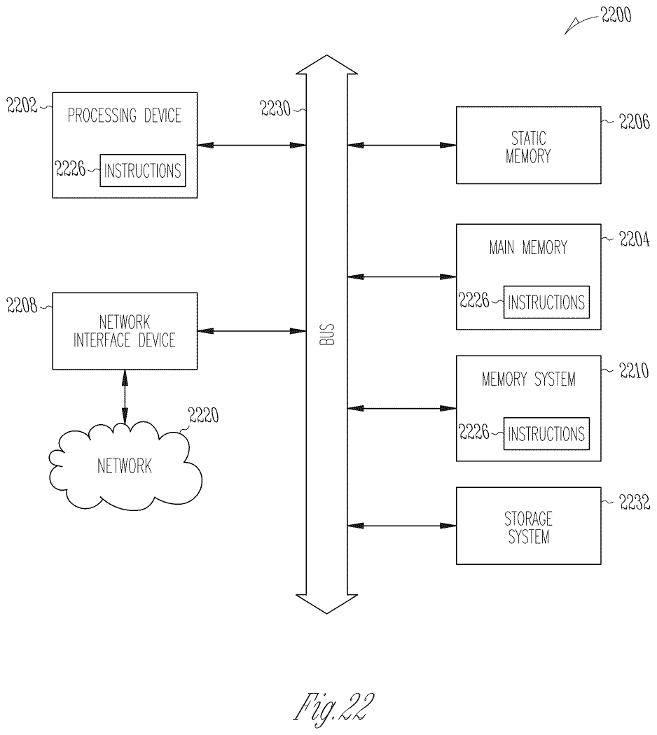

FIG. 21 is a flow diagram of an example of a method 2100 of

operating a computing system. At block 2105, the memory controller 211 of a memory system 110 prefetches at least two cache lines of the memory system as a combined cache line in response to a memory access request from a host 105 of the computing system. At block 2110, the memory controller performs chip fail error recovery to detect errors on data of the combined cache line. Thus, the method 2100 includes the techniques shown in the lower middle and lower right blocks in the diagram of FIG. 20.

FIG. 22 illustrates a block diagram of an example machine 2200 (e.g., a computing system) upon which any one or more of the techniques (e.g., methodologies) discussed herein may be performed. In alternative embodiments, the machine 2200 may operate as a standalone device or may be connected (e.g., networked) to other machines. In a networked deployment, the machine 2200 may operate in the capacity of a network node. In an example, the machine 2200 may act as a peer machine in peer-to-peer (P2P) (or other distributed) network environment. The machine 2200 may be a personal computer (PC), a tablet PC, a set-top box (STB), a personal digital assistant (PDA), a mobile telephone, a web appliance, an IoT device, an automotive computing system, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Examples, as described herein, may include, or may operate by, logic, components, devices, packages, or mechanisms. Circuitry is a collection (e.g., set) of circuits implemented in tangible entities that include hardware (e.g., simple circuits, gates, logic, etc.). Circuitry membership may be flexible over time and underlying hardware variability. Circuitries include members that may, alone or in combination, perform specific tasks when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable participating hardware (e.g., the execution units or a loading mechanism) to create members of the circuitry in hardware via the variable connections to carry out portions of the specific tasks when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

The machine 2200 (e.g., computing system) may include a processing device 2202 (e.g., a hardware processor, a central processing unit (CPU), a graphics processing unit (GPU), a hardware processor core, or any combination thereof, etc.), a main memory 2204 (e.g., read-only memory (ROM), dynamic random-access memory (DRAM) such as synchronous DRAM (SDRAM) or Rambus DRAM (RDRAM), etc.), a static memory 2206 (e.g., static random-access memory (SRAM), etc.), a memory system 2218, and a storage system 2232, some or all of which may communicate with each other via a communication interface (e.g., a bus) 2230.

The processing device 2202 can represent one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 2202 can also be one or more special-purpose processing devices such as an application specific integrated circuit (ASIC), a field programmable gate array (FPGA), a digital signal processor (DSP), network processor, or the like. The processing device 2202 can be configured to execute instructions 2226 for performing the operations and steps discussed herein. The computer system can further include a network interface device 2208 to communicate over a network 2220.

The memory system 2210 can include a machine-readable storage medium (also known as a computer-readable medium) on which is stored one or more sets of instructions 2226 or software embodying any one or more of the methodologies or functions described herein. The instructions 2226 can also reside, completely or at least partially, within the main memory 2204 or within the processing device 2202 during execution thereof by the computer system, the main memory 2204 and the processing device 2202 also constituting machine-readable storage media.

The term “machine-readable storage medium” should be taken to include a single medium or multiple media that store the one or more sets of instructions, or any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media. In an example, a massed machine-readable medium comprises a machine-readable medium with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The machine 2200 may further include a display unit, an alphanumeric input device (e.g., a keyboard), and a user interface (UI) navigation device (e.g., a mouse). In an example, one or more of the display units, the input device, or the UI navigation device may be a touch screen display. The machine 2200 can include a signal generation device (e.g., a speaker), or one or more sensors, such as a global positioning system (GPS) sensor, compass, accelerometer, or one or more other sensors. The machine 2200 may include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The instructions 2226 (e.g., software, programs, an operating system (OS), etc.) or other data stored on the storage system 2218 can be accessed by the main memory 2204 for use by the processing device 2202. The main memory 2204 (e.g., DRAM) is typically fast, but volatile, and thus a different type of storage than the storage system 2218 (e.g., an SSD), which is suitable for long-term storage, including while in an “off” condition. The instructions 2226 or data in use by a user or the machine 2200 are typically loaded in the main memory 2204 for use by the processing device 2202. When the main memory 2204 is full, virtual space from the memory system 2218 can be allocated to supplement the main memory 2204; however, because the memory system 2218 device is typically slower than the main memory 2204, and write speeds are typically at least twice as slow as read speeds, use of virtual memory can greatly reduce user experience due to storage system latency (in contrast to the main memory 2204, e.g., DRAM). Further, use of the storage system 2218 for virtual memory can greatly reduce the usable lifespan of the storage system 2218.

The instructions 2224 may further be transmitted or received over a network 2220 using a transmission medium via the network interface device 2208 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 2208 may include one or more physical jacks (e.g., Ethernet, coaxial, or phone jacks) or one or more antennas to connect to the network 2220. In an example, the network interface device 2208 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 2200, and includes digital or analog communications signals or other intangible medium to facilitate communication of such software.

1The above detailed description includes references to the accompanying drawings, which form a part of the detailed description. The drawings show, by way of illustration, specific embodiments in which the invention can be practiced. These embodiments are also referred to herein as “examples”. Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein”. Also, in the following claims, the terms “including” and “comprising” are open-ended, that is, a system, device, article, or process that includes elements in addition to those listed after such a term in a claim are still deemed to fall within the scope of that claim. 1Moreover, in the following claims, the terms “first,” “second,” and “third,” etc. are used merely as labels, and are not intended to impose numerical requirements on their objects.

In various examples, the components, controllers, processors, units, engines, or tables described herein can include, among other things, physical circuitry or firmware stored on a physical device. As used herein, “processor” means any type of computational circuit such as, but not limited to, a microprocessor, a microcontroller, a graphics processor, a digital signal processor (DSP), or any other type of processor or processing circuit, including a group of processors or multi-core devices.

The term “horizontal” as used in this document is defined as a plane parallel to the conventional plane or surface of a substrate, such as that underlying a wafer or die, regardless of the actual orientation of the substrate at any point in time. The term “vertical” refers to a direction perpendicular to the horizontal as defined above. Prepositions, such as “on,” “over,” and “under” are defined with respect to the conventional plane or surface being on the top or exposed surface of the substrate, regardless of the orientation of the substrate; and while “on” is intended to suggest a direct contact of one structure relative to another structure which it lies “on” in the absence of an express indication to the contrary); the terms “over” and “under” are expressly intended to identify a relative placement of structures (or layers, features, etc.), which expressly includes—but is not limited to—direct contact between the identified structures unless specifically identified as such. Similarly, the terms “over” and “under” are not limited to horizontal orientations, as a structure may be “over” a referenced structure if it is, at some point in time, an outermost portion of the construction under discussion, even if such structure extends vertically relative to the referenced structure, rather than in a horizontal orientation.

The terms “wafer” and “substrate” are used herein to refer generally to any structure on which integrated circuits are formed, and also to such structures during various stages of integrated circuit fabrication. The following detailed description is, therefore, not to be taken in a limiting sense, and the scope of the various embodiments is defined only by the appended claims, along with the full scope of equivalents to which such claims are entitled.

Various embodiments according to the present disclosure and described herein include memory utilizing a vertical structure of memory cells (e.g., NAND strings of memory cells). As used herein, directional adjectives will be taken relative a surface of a substrate upon which the memory cells are formed (i.e., a vertical structure will be taken as extending away from the substrate surface, a bottom end of the vertical structure will be taken as the end nearest the substrate surface and a top end of the vertical structure will be taken as the end farthest from the substrate surface).

In some embodiments described herein, different doping configurations may be applied to a select gate source (SGS), a control gate (CG), and a select gate drain (SGD), each of which, in this example, may be formed of or at least include polysilicon, with the result such that these tiers (e.g., polysilicon, etc.) may have different etch rates when exposed to an etching solution. For example, in a process of forming a monolithic pillar in a 3D semiconductor device, the SGS and the CG may form recesses, while the SGD may remain less recessed or even not recessed. These doping configurations may thus enable selective etching into the distinct tiers (e.g., SGS, CG, and SGD) in the 3D semiconductor device by using an etching solution (e.g., tetramethylammonium hydroxide (TMCH)).

Operating a memory cell, as used herein, includes reading from, writing to, or erasing the memory cell. The operation of placing a memory cell in an intended state is referred to herein as “programming,” and can include both writing to or erasing from the memory cell (i.e., the memory cell may be programmed to an erased state).

According to one or more embodiments of the present disclosure, a memory controller (e.g., a processor, controller, firmware, etc.) located internal or external to a memory system, is capable of determining (e.g., selecting, setting, adjusting, computing, changing, clearing, communicating, adapting, deriving, defining, utilizing, modifying, applying, etc.) that a memory data error occurs during a memory operation and a memory system fault occurs. The memory controller may be configured to coordinate reporting of detection of memory data errors with detection of memory system faults.

It will be understood that when an element is referred to as being “on,” “connected to” or “coupled with” another element, it can be directly on, connected, or coupled with the other element or intervening elements may be present. In contrast, when an element is referred to as being “directly on,” “directly connected to” or “directly coupled with” another element, there are no intervening elements or layers present. If two elements are shown in the drawings with a line connecting them, the two elements can either be coupled, or directly coupled, unless otherwise indicated.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code can be tangibly stored on one or more volatile or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

Example 1 includes subject matter (such as a memory system) comprising a memory array including memory cells that are included in multiple memory dies, and memory controller operatively coupled to the memory dies. The memory controller includes at least one of controller processing circuitry configured to prefetch at least two cache lines as a combined cache line in response to a memory access request and error recovery circuitry configured to provide less than full data recovery from a chip fail event.

In Example 2, the subject matter of Example 1 optionally includes a memory controller including both of the controller processing circuitry configured to prefetch the at least two cache lines as a combined cache line in response to a memory access request, and the error recovery circuitry configured to provide less than full data recovery of the combined cache line from a chip fail event.

In Example 3, the subject matter of one or both of Examples 2 and 3 optionally includes a memory controller having error recovery circuitry configured to perform reduced Reed Solomon chip fail error correction on the combined cache line.

In Example 4, the subject matter of one or both of Examples 2 and 3 optionally includes a memory controller having error recovery circuitry configured to detect errors in the combined cache line using parity determined on Reed Solomon symbols of codewords of the combined cache line.

In Example 5, the subject matter of one or any combination of Examples 2-4 optionally includes a memory controller having controller processing circuitry configured to write the combined cache line as split codewords striped across the memory dies and error recovery circuitry configured to correct errors in the combined cache line using parity determined on Reed Solomon symbols of the split codewords of the combined cache line.

In Example 6, the subject matter of one or any combination of Examples 2-5 optionally includes a memory controller having error recovery circuitry configured to perform a reduced locked redundant array of independent disks (LRAID) chip fail error correction on the combined cache line.

In Example 7, the subject matter of one or any combination of Examples 2-6 optionally includes a memory controller having error recovery circuitry configured to detect errors in the combined cache line using cyclic redundancy code (CRC) and locked redundant array of independent disks (LRAID) parity on the combined cache line.

In Example 8, the subject matter of one or any combination of Examples 1-7 optionally includes a memory controller having controller processing circuitry configured to prefetch one cache line in response to the memory request, and error recovery circuitry configured to perform reduced Reed Solomon chip fail error correction on the one cache line.

In Example 9, the subject matter of one or any combination of Examples 1-8 optionally includes a memory controller having controller processing circuitry configured to prefetch one cache line in response to the memory request and error recovery circuitry configured to detect errors in the one cache line using parity determined on Reed Solomon symbols of codewords of the one cache line.

In Example 10, the subject matter of one or any combination of Examples 1-9 optionally includes a memory controller having controller processing circuitry configured to prefetch one cache line in response to the memory request, and error recovery circuitry configured to perform reduced locked redundant array of independent disks (LRAID) chip fail error correction on the one cache line.

In Example 11, the subject matter of one or any combination of Examples 1-10 optionally includes a microcontroller having controller processing circuitry configured to prefetch one cache line in response to the memory request, and error recovery circuitry configured to detect errors in the one cache line using cyclic redundancy code (CRC) and locked redundant array of independent disks (LRAID) parity.

In Example 12, the subject matter of one or any combination of Examples 1 -11 optionally includes a microcontroller having controller processing circuitry configured to prefetch the at least two cache lines as a combined cache line in response to a memory access request, and error recovery circuitry configured to provide full chip fail recovery on data of the combined cache line.

Example 13 includes subject matter (such as a method of operating a computing system) or can optionally be combined with one or any combination of Examples 1-12 to include such subject matter, comprising prefetching, by a memory controller of a memory system of the computing system, at least two cache lines as a combined cache line in response to a memory access request from a host system of the computing system, and performing, by the memory controller, reduced chip fail error recovery to detect errors on data of the combined cache line.

In Example 14, the subject matter of Example 13 optionally includes performing reduced Reed Solomon chip fail error correction on the combined cache line.

In Example 15, the subject matter of one or both of Examples 13 and 14 optionally includes determining split Reed Solomon symbols of the combined cache line and determining parity of the split Reed Solomon symbols.

In Example 16, the subject matter of one or any combination of Examples 13-15 optionally includes performing a reduced locked redundant array of independent disks (LRAID) chip fail error correction on the combined cache line.

In Example 17, the subject matter of one or any combination of Examples 13-16 optionally includes detecting errors in the combined cache line using a split locked redundant array independent disk cyclic redundancy code (LRAID CRC) check and a split LRAID parity check on each half of two halves of the combined cache line.

Example 18 includes subject matter (such as a memory system) or can optionally be combined with one or any combination of Examples 1-17 to include such subject matter, comprising a memory system including a memory array including memory cells that are included in multiple memory dies, and a memory controller operatively coupled to the memory dies, and a host system including host processing circuitry configured to send a memory request to the memory system. The memory controller includes controller processing circuitry configured to prefetch at least two cache lines as a combined cache line in response to a memory access request, and error recovery circuitry configured to provide reduced chip fail error recovery on the combined cache line.

In Example 19, the subject matter of Example 18 optionally includes error recovery circuitry configured to perform a locked redundant array independent disk (LRAID) error recovery on the combined cache line.

In Example 20, the subject matter of one or both of Examples 18 and 19 optionally includes error recovery circuitry configured to perform Reed Solomon error recovery on the combined cache line.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A memory system comprising:
a memory array including memory cells that are included in multiple memory dies; and
a memory controller operatively coupled to the memory dies and including at least one of:
controller processing circuitry configured to prefetch at least two cache lines as a combined cache line in response to a memory access request; and
error recovery circuitry configured to provide less than full data recovery from a chip fail event.

2. The memory system of claim 1, wherein the memory controller includes both of the controller processing circuitry configured to prefetch the at least two cache lines as a combined cache line in response to a memory access request, and the error recovery circuitry configured to provide less than full data recovery of the combined cache line from the chip fail event.

3. The memory system of claim 2, wherein the error recovery circuitry is configured to perform reduced Reed Solomon chip fail error correction on the combined cache line.

4. The memory system of claim 2, wherein the error recovery circuitry is configured to detect errors in the combined cache line using parity determined on Reed Solomon symbols of codewords of the combined cache line.

5. The memory system of claim 2,
wherein the controller processing circuitry is configured to write the combined cache line as split codewords striped across the memory dies;
wherein the error recovery circuitry is configured to correct errors in the combined cache line using parity determined on Reed Solomon symbols of the split codewords of the combined cache line.

6. The memory system of claim 2, wherein the error recovery circuitry is configured to perform a reduced locked redundant array of independent disks (LRAID) chip fail error correction on the combined cache line.

7. The memory system of claim 2, wherein the error recovery circuitry is configured to detect errors in the combined cache line using cyclic redundancy code (CRC) and locked redundant array of independent disks (LRAID) parity on the combined cache line.

8. The memory system of claim 1,
wherein the controller processing circuitry is configured to prefetch one cache line in response to the memory request; and
wherein the error recovery circuitry is configured to perform reduced Reed Solomon chip fail error correction on the one cache line.

9. The memory system of claim 1,
wherein the controller processing circuitry is configured to prefetch one cache line in response to the memory request; and
wherein the error recovery circuitry is configured to detect errors in the one cache line using parity determined on Reed Solomon symbols of codewords of the one cache line.

10. The memory system of claim 1,
wherein the controller processing circuitry is configured to prefetch one cache line in response to the memory request; and
wherein the error recovery circuitry is configured to perform a reduced locked redundant array of independent disks (LRAID) chip fail error correction on the one cache line.

11. The memory system of claim 1,
wherein the controller processing circuitry is configured to prefetch one cache line in response to the memory request; and
wherein the error recovery circuitry is configured to detect errors in the one cache line using cyclic redundancy code (CRC) and locked redundant array of independent disks (LRAID) parity.

12. The memory system of claim 1,
wherein the controller processing circuitry configured to prefetch the at least two cache lines as a combined cache line in response to a memory access request; and
wherein the error recovery circuitry configured to provide full chip fail recovery on data of the combined cache line.

13. A method of operating a computing system, the method comprising:
prefetching, by a memory controller of a memory system of the computing system, at least two cache lines as a combined cache line in response to a memory access request from a host system of the computing system; and
performing, by the memory controller, reduced chip fail error recovery to detect errors on data of the combined cache line.

14. The method of claim 13, wherein the performing reduced chip fail error recovery includes performing reduced Reed Solomon chip fail error correction on the combined cache line.

15. The method of claim 13, wherein the performing reduced chip fail error recovery includes determining split Reed Solomon symbols of the combined cache line and determining parity of the split Reed Solomon symbols.

16. The method of claim 13, wherein the performing reduced chip fail error recovery includes performing reduced locked redundant array of independent disks (LRAID) chip fail error correction on the combined cache line.

17. The method of claim 13, wherein the performing reduced chip fail error recovery includes detecting errors in the combined cache line using a split locked redundant array independent disk cyclic redundancy code (LRAID CRC) check and a split LRAID parity check on each half of two halves of the combined cache line.

18. A computing system comprising:
a memory system including a memory array including memory cells that are included in multiple memory dies, and a memory controller operatively coupled to the memory dies; and
a host system including host processing circuitry configured to send a memory request to the memory system; and
wherein the memory controller includes:
controller processing circuitry configured to prefetch at least two cache lines as a combined cache line in response to a memory access request; and
error recovery circuitry configured to provide reduced chip fail error recovery on the combined cache line.

19. The computing system of claim 18, wherein the error recovery circuitry is configured to perform a locked redundant array independent disk (LRAID) error recovery on the combined cache line.

20. The computing system of claim 18, wherein the error recovery circuitry is configured to perform Reed Solomon error recovery on the combined cache line.
